(19) United States
(12) Patent Application Publication
(10) Pub. No.: US 2006/0263530 A1
(43) Pub. Date: Nov. 23, 2006

(54) Process for making non-continuous articles with microstructures

(75) Inventors: Nitin Vaish, Evansville, IN (US); Dennis Joseph Coyle, Clifton Park, NY (US); Simon Yeung, Evansville, IN (US)

Correspondence Address: FOLEY AND LARDNER LLP;SUITE 500, 3000 K STREET NW, WASHINGTON, DC, 20007, US

(73) Assignee: General Electric Company

(21) Appl. No.: 11/132,439

(22) Filed: May 19, 2005

(51) Int. Cl. B32B 3/00; B05D 3/12; B05C 1/00

(52) U.S. Cl. 427/355; 428/156; 118/211

(57) ABSTRACT

A system and process for making non-continuous articles with patterned microstructures. The articles are of high quality and may be used in flat panel display applications. The system and process use a casting roll with a pattern on the surface of the casting roll for patterning a non-continuous microstructure on a surface of the substrate, and a coating device that is adapted to apply a coating to the surface of the substrate in a non-continuous manner so that areas of the substrate that are coated by the coating device correspond to the casting roll pattern.

### BACKGROUND

The present invention relates to a system for making articles with microstructures and a process for making such articles.

In conventional processes for making continuous patterned articles, plastic substrates are coated via spraying, brushing, roll coating, extrusion coating, or the like. Such processes are used to make articles for display applications, such as diffuser films and brightness enhancement films, for retroreflective sheeting used in traffic signs and such, and other application requiring precise microstructures on films or sheets.

U.S. Pat. No. 4,420,502 discloses a continuous process for manufacturing flexible sheet material with desired surface characteristics. In this process a base film is advanced over a roll that continuously applies coating material to the base film. The base film then contacts the pattern surface of a second roll that continuously patterns a desired surface characteristic in the coating material. The coating material is then cured and hardened on the base film by radiation.

U.S. Pat. No. 5,468,542 discloses a process of continuously producing substrates with abrasion-resistant coatings. A substrate contacts a transfer roll which continuously coats the substrate with coating material. The substrate then contacts a casting drum with a pattern on its surface for patterning the coating material on the substrate. Ultraviolet radiation is then used to cure the coating material on the substrate.

A typical process for mass-producing microstructures on film and sheet begins with creating the original version of the geometry, called a master. Such a master is typically very difficult and expensive to create and is typically either made in photoresist on glass via photolithography processes or by micromachining in soft metal. Many copies of these masters are then made via conventional electroforming processes to give discrete metal plates with near-perfect copies of the microstructure. These plates or tools are then used to mass-produce plastic films or sheets with the microstructure via embossing a thermoplastic film with the tool or by casting reactive monomers onto the tool and UV-curing this coating to replicate the microstructure. Since the tools are discrete plates the coating must be applied only to the plate area, or the region of the base film which will align with the plate. If coating over-runs the plate edges it will tend to pull the tool off of it's supporting roller and destroy it, and possibly leave cosmetic defects in the final product. Thus coating must be applied in patches, not continuously as most coating processes do. In addition, these patches of coating must align with the tool, which is typically on another drum with a certain circumference.

A typical method of coating patches is the gravure coating method, where the coating is printed onto the base film by transfer from engraved regions of the gravure roll. If only part of the circumference of the gravure roll is engraved, then patches will be coated. The repeat length of these patches is determined by the circumference of the gravure roll, so that this circumference must be perfectly matched to the circumference of the drum which carries the tool. Furthermore, the engraved circumferential length of the gravure roll must be matched to the length of the tool. Any change of length of the tool requires a new gravure roll. Also, the volume of coating deposited onto the web is governed by the engraving and can not be adjusted. Thus it is difficult to efficiently coat a variety of products with a conventional gravure coater.

Another conventional patch coating method is flexographic printing, where a continuously-engraved gravure roll, known as an anilox roll, applies coating to the raised regions of an adjacent-rotating blanket roll. Only the raised regions of the blanket roll will transfer wet coating onto the base film it comes in contact with. The limitations are similar to the above-mentioned gravure coater—the repeat length is determined by blanket-roll circumference, patch size is determined by the size of the raised region of the blanket roll, and the coating thickness cannot be adjusted.

### SUMMARY OF THE INVENTION

According to an embodiment of the present invention, a system for making articles with microstructures is provided that includes a payoff reel for supplying a substrate, a casting roll with a pattern on the surface of the casting roll for patterning a non-continuous microstructure on a surface of the substrate, and a coating device that is adapted to apply a coating to the surface of the substrate in a non-continuous manner so that areas of the substrate that are coated by the coating device correspond to the casting roll pattern.

The present invention may be advantageously used to provide a system and process for making patterned articles of high quality that may be used in flat panel display applications. The present invention may be advantageously used to provide a system and process for making patterned articles of high quality with excellent optical properties, good cosmetics, and minimal point defects.

In an embodiment of the present invention, a method for making articles with microstructures is provided by supplying a continuous substrate, providing a casting roll with a pattern on the surface of the casting roll for patterning a non-continuous microstructure on a surface of the substrate, using a coating device to apply a coating to the surface of the substrate in a non-continuous manner so that areas of the substrate coated by the coating device correspond to the casting roll pattern and patterning coated areas of the substrate with the casting roll.

According to an embodiment of the present invention, an article with non-continuous, patterned microstructures is provided that includes a substrate and a series of non-continuous microstructures patterned on a surface of the substrate, wherein the microstructure is formed by supplying the substrate, providing a casting roll with a pattern on the surface of the casting roll for patterning a microstructure on the surface of the substrate, using a coating device to apply a coating to the surface of the substrate in a non-continuous manner so that areas of the substrate coated by the device correspond to the casting roll pattern, and patterning coated areas with the casting roll.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 shows a side view of a system for making non-continuous articles with patterned microstructures according to an embodiment of the present invention.

FIG. 2a shows a side view of a system for applying non-continuous patches of coating to a substrate according to an embodiment of the present invention in which the substrate is in an engaged state with a coating device.

FIG. 2b shows a side view of a system for applying non-continuous patches of coating to a substrate according to an embodiment of the present invention in which the substrate is in a disengaged state with a coating device.

FIG. 3 shows a side view of dancer roll for maintaining substrate tension according to an embodiment of the present invention.

FIG. 4a shows a side view of a system for applying non-continuous patches of coating to a substrate according to an embodiment of the present invention in which the substrate is in an engaged state with a coating device.

FIG. 4b shows a side view of a system for applying non-continuous patches of coating to a substrate according to an embodiment of the present invention in which the substrate is in a disengaged state with a coating device.

FIG. 5 shows a side view of a coating device that applies patches of coating to a substrate in a reverse direction according to an embodiment of the present invention.

FIG. 6 is a view of a gravure coating roll according to an embodiment of the present invention.

FIG. 7 shows a side view of a coating device that applies patches of coating to a substrate in a forward direction according to an embodiment of the present invention.

### DETAILED DESCRIPTION

Embodiments of the present invention will be described below with reference to the drawings.

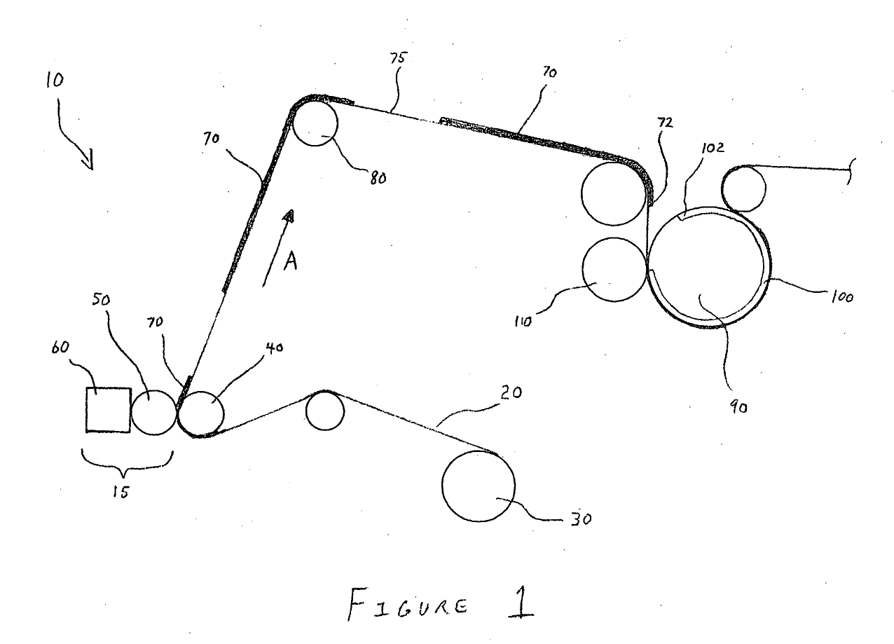

FIG. 1 shows a side view of a coating system 10 for making articles with microstructures according to an embodiment of the present invention. In the example shown in FIG. 1, a substrate 20 is supplied from a payoff reel 30. Other devices for supplying a substrate 20 may be used, as is known in the art. The substrate 20 is advanced through the system in the direction indicated by arrow A. The substrate 20 is supplied to a nip between a backing roll 40 and an applicator roll 50 where the substrate is coated with a coating material that is supplied from a coating material source 60. The applicator roll 50 and coating material source 60 form a coating device 15 for coating non-continuous patches of coating material onto a surface of the substrate 20, forming areas of coated substrate 70 that are separated by uncoated substrate areas 75. The coating material is preferably a material that is curable with UV radiation.

The system for making articles with microstructures may include a substrate tension adjustment device for maintaining a desired substrate tension, as will be explained further. In the example shown in FIG. 1, the system includes a substrate tension adjustment device 80 for increasing or decreasing substrate tension to maintain a desired substrate tension as the backing roll 40 alternately engages and disengages the coating device, as will be explained in detail below. The substrate tension device may include a dancer roll or other spring loaded roll or device that applies a constant force to the substrate.

The substrate 20 is then supplied to a nip between a casting roll 90 and a nip roll 110. The casting roll 90 includes a pattern 100 that covers a portion of the surface of casting roll 90. The pattern 100 is used to replicate a desired microstructure upon coated areas 70 of the substrate. The nip may apply a sufficient pressure to the coating to control coating thickness, exclude entrapment of air, and replicate the desired microstructures. The coated areas 70 of the substrate correspond to the pattern 100 on the surface of the casting roll 90 so that coated areas 70 of the substrate are imprinted by the pattern 100, replicating a desired microstructure.

For example, the length of coated areas 70 of the substrate may be the same length as the arc length of the pattern 100. In a further example, the casting roll 90 may turn at a rate so that the front edge 102 of the pattern 100 meets the front edge 72 of a coated area 70 of the substrate. The placement of the coated areas 70 on the substrate may correspond to areas of the substrate that the pattern 100 will come into contact with. In another example, the coating device 15 may be controlled so that the coated areas 70 are synchronized with the pattern 100 on the casting roll 90.

In another example, a coated area 70 on the substrate may reach the pattern 100 just after the pattern has engaged the substrate. For example, a 0.5-1 inch gap may exist between the point where the pattern 100 has engaged the substrate and where the front edge of a coated area 70 engages the pattern 100. This helps to make sure that coating does not get under the front edge of tool or pattern 100. In a further example, the coating patch may also end 1-5 inches before the end of the pattern 100. These gaps between the front and back edges of a coated area 70 and the pattern 100 may be used to prevent damage to the coating material or microstructure due to adherence between an edge of the pattern 100 and the coating material. The gaps between the front and back edges of a coated area 70 and the pattern 100 may be adjustable to provide manufacturing efficiency.

The casting roll 90 may be interchangeable, allowing casting rolls of varying diameter and pattern length to be used. This provides process flexibility by allowing different sizes of microstructure patterns to be replicated on a substrate. The patterned area of the casting drum may be created by adhering a tool plate to the surface of a smooth drum. Such a plate could be any size depending on the desired product to be run on a given day, allowing the patch length to be easily changed.

After the pattern 100 of the casting roll 90 has replicated the desired microstructure in coated areas 70 of the substrate, the substrate is cured by UV lamps (not shown) to form non-continuous patterned microstructures on the substrate. For example, UV radiation may be directed through the base of the substrate to cure patterned coating material. The substrate may also pass by surface curing lamps (not shown) and further processes. For example, the application of masking, edge trimming, or die cutting (not shown) may be performed. After processing is complete, the substrate is then collected by a collection device. For example, a take-up reel or other devices known in the art may be used as collection devices. The finished article, which may be a light management film for assembly in a backlight module in a liquid crystal display, may then be converted into a suitable format for handling and further processing.

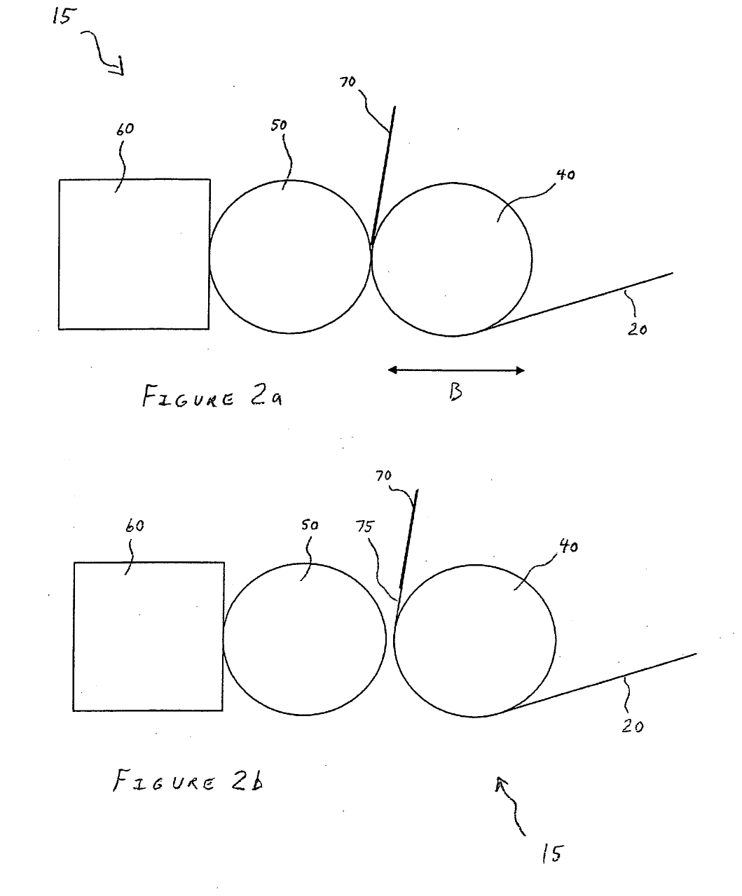

FIG. 2a shows a side view of a coating device 15 according to an embodiment of the present invention. The coating device 15 may include an applicator roll 50 and a coating material source 60. The coating can be heated to a desired temperature range, either by in-line heaters, hot fluid or the like, prior to application of the coating to the substrate 20. The coating material source 60 may supply coating material to the applicator roll 50, which may then apply the coating material to the substrate 20 to create a non-continuous coated area 70. The backing roll 40 may serve to hold the substrate 20 and press the substrate against the applicator roll 50. As illustrated in the example shown in FIG. 1, the coated areas 70 may be separated by uncoated areas 75 where coating material is not applied to the substrate 20.

FIGS. 2a and 2b show an example of a coating device 15 that applies coating material to the substrate 20 by periodically moving the backing roll 40 to create non-continuous coated areas 70 that are separated by uncoated areas 75. For example, the backing roll 40 and substrate 20 may engage the coating device 15, to allow coating material to be applied to the substrate 20, and the backing roll 40 and substrate 20 may alternately move to disengage from the coating device 15, so that application of coating material is stopped. In the example shown in FIGS. 2a and 2b, the backing roll 40 moves in the direction indicated by arrow B, causing the backing roll 40 and substrate 20 to engage the applicator roll 50 and alternately disengage the backing roll 40 and substrate 20 from the applicator roll 50.

FIG. 2a shows an example of the backing roll 40 and substrate 20 in an engaged state while FIG. 2b shows an example of the backing roll 40 and substrate 20 in a disengaged state. When the substrate 20 is engaged with the applicator roll 50, coating material may be applied to the substrate 20 to create non-continuous coated areas 70. When the substrate 20 is disengaged with the applicator roll 50, uncoated areas 75 are created. The disengagement of the substrate 20 and the applicator roll 50 stops the coating process, making the coated areas 75 non-continuous patches rather than a continuous coating on the substrate 20.

The speed of the applicator roll may be adjusted independently of the substrate speed because the patch length is controlled by the engagement/disengagement mechanism, whereas in conventional patch coating the speeds of the applicator roll and the substrate must be equal and the repeat length is determined by the circumference of the roll. By adjusting the speed of the applicator one may independently adjust the coating thickness. For example, increasing the applicator speed in a reverse-acting coater will pile more coating onto the substrate and give the product a thicker coating.

An actuator may be used to move the backing roll 40. For example, piston-cylinders, rack and pinions, cams, linkages, screws, servo-motors, combinations of these devices, and other actuators known in the art may be used to move the backing roll 40.

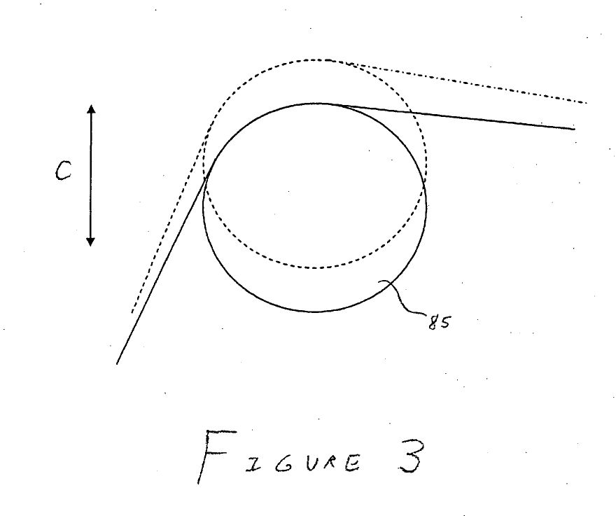

When the backing roll 40 is moved to create non-continuous coated areas, as in the example shown in FIGS. 2a and 2b, the tension of the substrate 20 may be affected due to the movement of the backing roll. To compensate for changes in substrate tension, a tension adjustment device 80 may be used to increase or decrease substrate tension to maintain a desired substrate tension. A tension adjustment device may include such devices as is known in the art of substrate processing. In the example shown in FIG. 3, a dancer roll 85 is used to adjust tension. The dancer roll 85 may be moved in the direction indicated by arrow C. For example, the dancer roll 85 may move from the position indicated by solid lines to the position indicated by dashed lines.

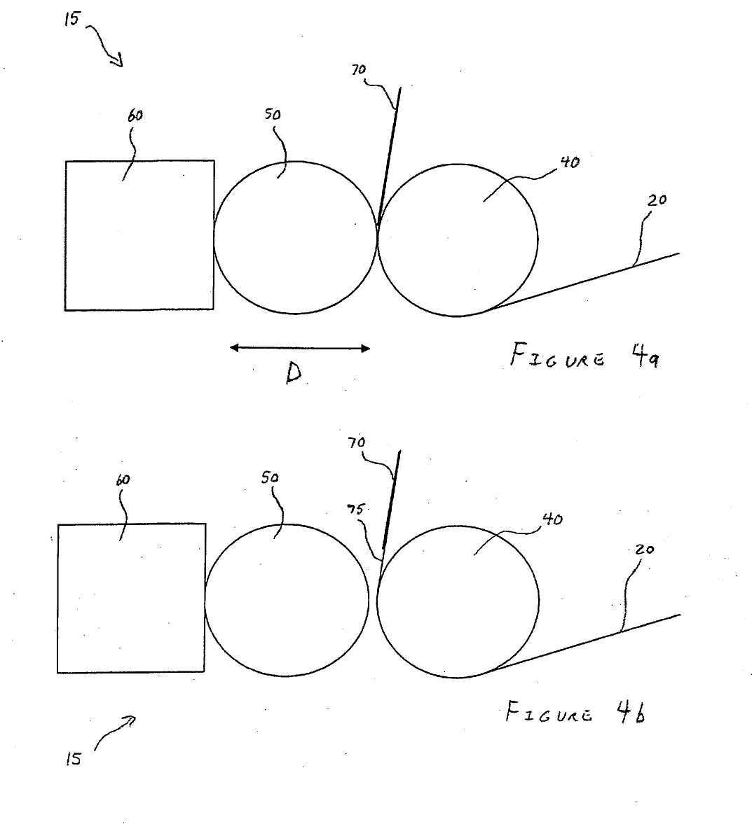

FIGS. 4a and 4b show an example of a coating device 15 according to an embodiment of the present invention. The coating device 15 may include an applicator roll 50 and a coating material source 60. In the example shown in FIGS. 4a and 4b, the coating device 15 may be periodically moved so that the applicator roll 50 engages the substrate 20 and alternately disengages with the substrate 20. In the example shown in FIGS. 4a and 4b, the coating device may move in the direction indicated by arrow D. When the applicator roll 50 engages the substrate 20, coating material is applied to the substrate to create non-continuous coated areas 70. FIG. 4a shows an example of the coating device 15 in an engaged state with the substrate 20 while FIG. 4b shows an example of the coating device 15 in a disengaged state with the substrate 20.

An actuator may be used to move the coating device 15, including the applicator roll 50 and coating material source 60. For example, piston-cylinders, rack and pinions, cams, linkages, screws, servo-motors, combinations of these devices, and other actuators known in the art may be used to move the coating device 15.

The timing of the movement of the backing roll 40 or coating device 15 may be set so that the coated areas 75 correspond to the pattern 100 on the casting roll 90. For example, the movement of the backing roll 40 or coating device 15 may be set so that the length of coated areas 75 corresponds to the arc length of the pattern 100 and so that coated areas 75 are areas of the substrate 20 that will come into contact with the pattern 100. The timing of the movement of the backing roll 40 or coating device 15 may be adjustable so that different lengths or size of coated areas may be produced, allowing different sizes of patterned microstructures to be manufactured.

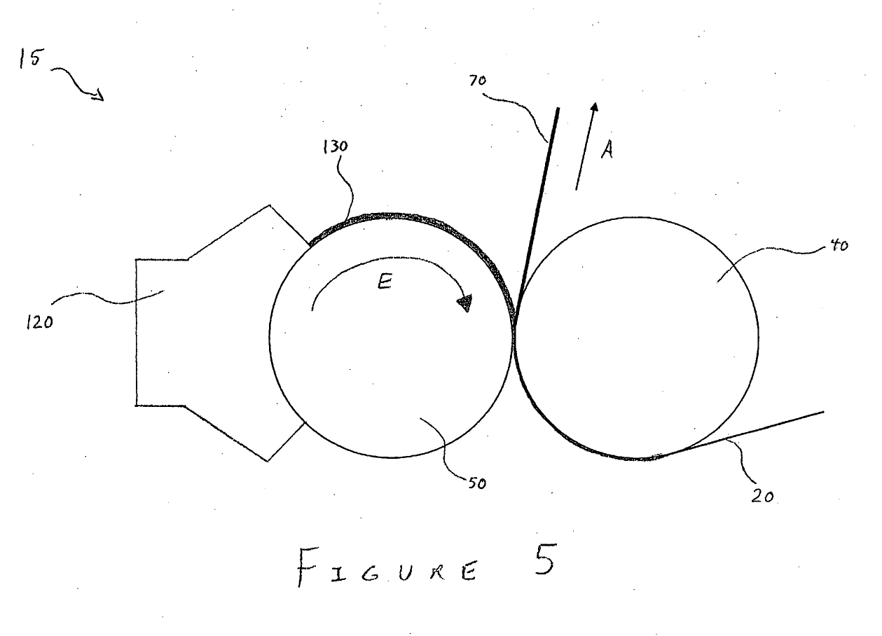

FIG. 5 shows an embodiment of the present invention in which the coating device 15 applies coating material 130 to the substrate 20 in a reverse direction. In the example shown in FIG. 5, a coating material source 120 applies coating material 130 to an applicator roll 50 that is rotating in a direction that is in reverse to the direction of the movement of the substrate 20. The rotation of the applicator roll 50 is indicated by arrow E while the direction of the substrate 20 is indicated by arrow A. When the applicator roll 50 moves in a reverse direction, the applicator roll 50 creates a wiping action with the substrate, causing coating material 130 on the applicator roll 50 to be applied to the substrate 20. In a reverse coating application, the applicator roll 50 may be a gravure roll, for example, or a smooth roll that has picked up coating liquid from a pan that may have a knife-edge positioned at a small separation from the roll to remove some of this liquid before it can be applied to the web.

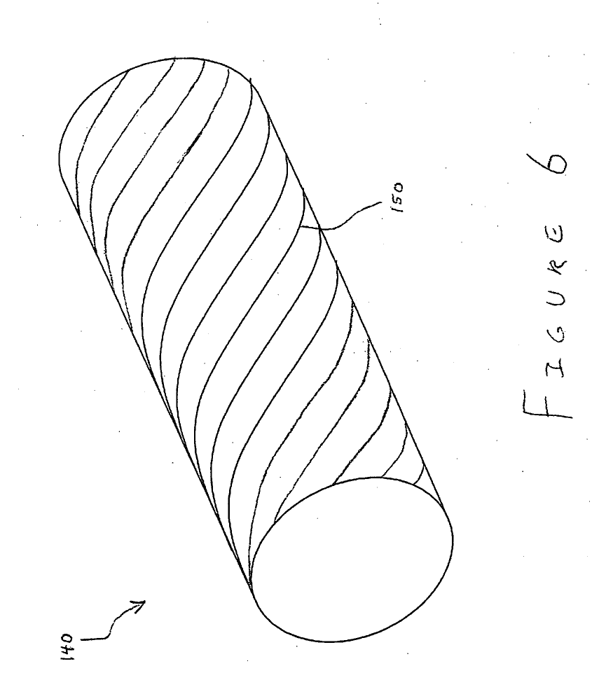

FIG. 6 shows an example of a gravure roll 140. Gravure rolls, as is known in the coating arts, may have a surface pattern for retaining a desired volume of coating material that will be applied to a substrate. In the example shown in FIG. 6, gravure roll 140 has spiral surface grooves 150 for retaining a desired amount of coating material 130 on the surface of the gravure roll 140.

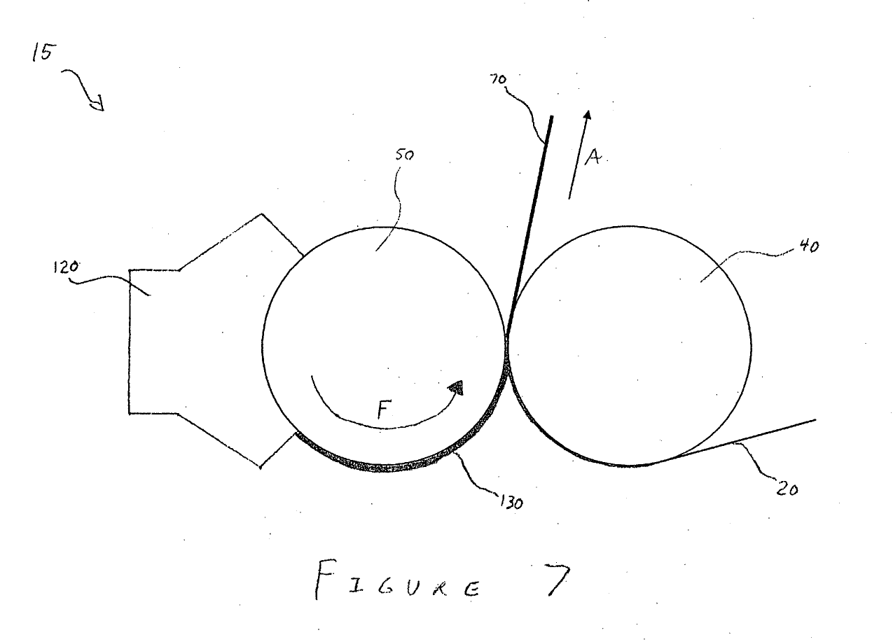

FIG. 7 shows an embodiment of the present invention in which the coating device 15 applies the coating material 130 to the substrate 20 in a forward direction. In the example shown in FIG. 5, a coating material source 120 applies coating material 130 to an applicator roll 50 that is rotating in a direction that is aligned with the direction of the movement of the substrate 20. The rotation of the applicator roll 50 is indicated by arrow F while the direction of the substrate 20 is indicated by arrow A. In a forward coating application, the applicator roll 50 may be a gravure roll.

The coating material source 120 may be a doctor blade or other coating applicator device as is known in the art. In a further embodiment of the present invention, the coating material source may be a die that coating material 130 may be extruded through. Coating material 130 may be supplied from the die and onto the applicator roll 50, which may move in a forward or reverse direction. When a die is used to supply coating material, the applicator roll 50 may be a smooth roll.

The coating material may be composed of acrylates, functionalized metal oxides of various sizes (including nanoparticles dispersed in a solution), or any other coatings with properties that are appropriate for the desired end-use of the produced article. For example, the acrylates can be a composition comprising multifunctional (meth)acrylates, substituted or unsubstituted arylether (meth)acrylate monomer, brominated aromatic (meth)acrylate monomer, and polymerization initiator.

The process parameters of the manufacturing process should be controlled to optimize operating costs and product performance through process uptime, process yield, and product cosmetics. For example, a higher line speed or lower casting nip pressure may result in air entrapment within the coating material. For example, increasing line speed from 10 FPM to 30 FPM, with all other process conditions being the same, may result in an almost 20% reduction in coating thickness to 33 μm. In another example, decreasing the casting nip force by 1-2 pli (pounds/linear inch) may result in a 16-fold increase in the quantity of air bubbles. The coating application temperature may have an effect as well. For example, lowering the coating application temperature from 120 to 110° F. may result in an almost 4-fold increase in the quantity of air bubbles.

In another example, low gravure roll application ratio may result in low coating thickness, affecting product performance and cosmetic quality. Coating thickness may be controlled to a desired range. For example, coating thickness may be controlled to a range of approximately 40-50 μm. Air bubble size may be controlled to a desired size. For example, air bubble size may be controlled to a size less than 200 μm.

In an example of the operation of the present process, the following process parameters may be used: a line speed of approximately 20-70 FPM, a casting nip force of approximately 2-20 PLI (pounds per linear inch) a gravure roll application ratio of approximately 0.75-2.0, a gravure backing roll force of approximately 3-15 PLI, a casting roll temperature of approximately 100-190° F., and a coating temperature of approximately 110-140° F.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A system for making articles with microstructures, comprising:
a payoff reel for supplying a substrate;
a casting roll with a pattern on the surface of the casting roll for patterning a non-continuous microstructure on a surface of the substrate; and
a coating device adapted to apply a coating to the surface of the substrate in a non-continuous manner so that areas of the substrate coated by the coating device correspond to the casting roll pattern,
wherein the coating device and substrate are adapted to periodically move relative to one another so that the coating device and substrate alternately engage for application of coating to the surface of the substrate, and alternately disengage so that the application of coating to the surface of the substrate is stopped.

2. The system of claim 1, further comprising:
a backing roll for supporting the substrate; and
an actuator for periodically moving the backing roll so that the backing roll engages the coating device for application of coating to the surface of the substrate, and alternately disengages the backing roll from the coating device so that application of coating to the surface of the substrate is stopped.

3. The system of claim 2, further comprising:
a substrate tension adjustment device that is adapted to increase or decrease substrate tension to maintain a desired substrate tension as the backing roll alternately engages and disengages the coating device.

4. The system of claim 3, wherein the tension adjustment device is a dancer roll that is adapted to move in a direction to increase substrate tension and move in another direction to decrease substrate surface tension.

5. The system of claim 1, further comprising:
an actuator for periodically moving the coating device so that the coating device alternately engages the substrate for application of coating to the surface of the substrate, and alternately disengages from the substrate so that application of coating to the surface of the substrate is stopped.

6. The system of claim 1, wherein the casting roll pattern is adapted to engage the substrate so that a front edge of the casting roll pattern engages the substrate at an adjustable distance ahead of a front edge of a coated area of the substrate.

7. The system of claim 1, wherein the casting roll pattern is adapted to form an adjustable gap between a back edge of the pattern and a back edge of a coated area of the substrate so that the pattern extends past the back edge of the coated area.

8. The system of claim 1, wherein the coating device is a gravure coating device.

9. The system of claim 8, wherein the gravure coating device is a reverse gravure coating device.

10. The system of claim 8, wherein the gravure coating device is a forward gravure coating device.

11. The system of claim 8, wherein the gravure coating device is adapted to use a gravure roll application ratio of approximately 0.75 to 2.0.

12. The system of claim 8, wherein the gravure coating device includes a backing roll that is adapted to apply a force of approximately 3-15 PLI.

13. The system of claim 1, wherein the coating device is a die extrusion coating device.

14. The system of claim 1, wherein the system is adapted to be adjustable so that an area coated on the substrate is adjustable in size.

15. The system of claim 1, wherein the system is adapted to run with a line speed of approximately 20 to 70 FPM.

16. The system of claim 1, wherein the casting roll forms a roll nip and the casting roll is adapted to apply a nip force of approximately 2-20 PLI.

17. The system of claim 1, wherein the casting roll is adapted to use a casting roll temperature of approximately 100° F. to 190° F.

18. The system of claim 1, wherein the system is adapted to heating the coating to approximately 110° F. to 140° F.

19. A method for making articles with microstructures, comprising:
supplying a continuous substrate;
providing a casting roll with a pattern on the surface of the casting roll for patterning a non-continuous microstructure on a surface of the substrate;
using a coating device to apply a coating to the surface of the substrate in a non-continuous manner so that areas of the substrate coated by the coating device correspond to the casting roll pattern, wherein the coating device and substrate periodically move relative to one another so that the coating device and substrate alternately engage for application of coating to the surface of the substrate, and alternately disengage so that the application of coating to the surface of the substrate is stopped; and
patterning coated areas of the substrate with the casting roll.

20. The method of claim 19, further comprising:
providing a backing roll for supporting the substrate that periodically moves so that the backing roll engages the coating device for application of coating to the surface of the substrate, and alternately disengages from the coating device so that application of coating to the surface of the substrate is stopped.

21. The method of claim 19, further comprising:
providing a dancer roll that increases or decreases substrate tension to maintain a desired substrate tension as the backing roll for supporting the substrate alternatively engages and disengages the coating device.

22. The method of claim 19, wherein the coating device periodically moves to alternately engage the substrate for application of coating to the surface of the substrate, and alternately disengages from the substrate so that application of coating to the surface of the substrate is stopped.

23. The method of claim 19, wherein the coating device is a gravure coating device.

24. The method of claim 23, wherein the gravure coating device is a reverse gravure coating device.

25. The method of claim 23, wherein the gravure coating device is a forward gravure coating device.

26. The method of claim 19, wherein the coating device is a die extrusion coating device.

27. The method of claim 19, wherein the system is adjustable so that an area coated on the substrate is adjustable in size.

28. The method of claim 19, wherein the casting roll pattern engages the substrate so that a front edge of the casting roll pattern engages the substrate at an adjustable distance ahead of a front edge of a coated area of the substrate.

29. The method of claim 19, wherein the casting roll pattern forms an adjustable gap between a back edge of the pattern and a back edge of a coated area of the substrate so that the pattern extends past the back edge of the coated area.

30. The method of claim 19, wherein the gravure coating device uses a gravure roll application ratio of approximately 0.75 to 2.0.

31. The method of claim 19, wherein the gravure coating device includes a backing roll that applies a force of approximately 3-15 PLI.

32. The method of claim 19, wherein the coating device is a die extrusion coating device.

33. The method of claim 19, wherein an area coated on the substrate is adjustable in size.

34. The method of claim 19, wherein a line speed of approximately 20 to 70 FPM is used.

35. The method of claim 19, wherein the casting roll forms a roll nip and the casting roll is applies a nip force of approximately 2-20 PLI.

36. The method of claim 19, wherein the casting roll uses a casting roll temperature of approximately 100° F. to 190° F.

37. The method of claim 19, wherein the coating is heated to approximately 110° F. to 140° F.

38. An optical film with a patterned microstructure, comprising:
a substrate;
a microstructure patterned on a surface of the substrate;
wherein the microstructure is formed by supplying the substrate, providing a casting roll with a pattern on the surface of the casting roll for patterning a non-continuous microstructure on the surface of the substrate, wherein the coating device and substrate periodically move relative to one another so that the coating device and substrate alternately engage for application of coating to the surface of the substrate, and alternately disengage so that the application of coating to the surface of the substrate is stopped, using a coating device to apply a coating to the surface of the substrate in a non-continuous manner so that areas of the substrate coated by the device correspond to the casting roll pattern, and patterning coated areas with the casting roll.
